(19) United States
(12) Patent Application Publication
(10) Pub. No.: US 2026/0341952 A1
(43) Pub. Date: Oct. 29, 2026

(54) ATTRITABLE DEVICE WITH PLASMONIC ANTENNAS FOR MESH NETWORK COMMUNICATION AND VERSATILE DEPLOYMENT

(71) Applicant: Saltenna Inc., McLean, VA (US)

(72) Inventors: Igor SMOLYANINOV, Columbia, MD (US); Quirino Balzano, Annapolis, MD (US); Sanjee Singla, Washington, DC (US)

(21) Appl. No.: 19/660,049

(22) Filed: Apr. 27, 2026

Related U.S. Application Data
(60) Provisional application No. 63/796,056, filed on Apr. 28, 2025.

(51) Int. Cl. H01Q 1/22; H01Q 1/42; H04L 9/32

(52) U.S. Cl. CPC H01Q 1/22; H01Q 1/42; H04L 9/32

(57) ABSTRACT

Methods, systems, and devices for using plasmonic and conventional antennas for adaptable mesh network communication are described. In some implementations, a device may include a plasmonic antenna configured to couple electromagnetic signals to surface electromagnetic waves and a conventional antenna configured for compatibility with standard communication systems. The device may receive data signals and process them to determine network routing parameters. Based on the determined parameters, instructions may be transmitted to the device for establishing mesh network communication. Secure data transmission within the mesh network may be managed by applying encryption and authentication protocols to the transmitted instructions, ensuring robust and adaptable communication in diverse environments.

### FIELD OF TECHNOLOGY

The present disclosure relates generally to communication devices, and more specifically to attritable device with plasmonic antennas for mesh network communication and versatile deployment.

### BACKGROUND

Communication networks are essential for enabling data exchange in various applications, including industrial operations, military missions, and remote monitoring. Traditional communication devices often rely on conventional antennas and standard radio frequency systems, which may be effective in controlled conditions but face significant limitations in challenging settings such as dense forests, urban areas, or underwater.

### SUMMARY

The described techniques relate to improved methods, systems, devices, and apparatuses that support techniques for attritable devices with plasmonic antennas for mesh network communication and versatile deployment. In this context, the term “attritable” may refer to a design characteristic where a system or weapon is intentionally made less reliable and maintainable to reduce its overall cost, making it suitable for use in large numbers and potentially for expendable or recoverable operations. Some implementations may provide a communication device designed to establish resilient and adaptable mesh networks in diverse environments. The device may integrate a plasmonic antenna for coupling electromagnetic signals to surface electromagnetic waves, enabling efficient signal propagation along surfaces. This may be complemented by a conventional antenna to ensure compatibility with standard radio frequency systems, providing versatility in communication methods. The device may be powered by a modular power source, which may include solar panels, batteries, or external power connectors, and may incorporate low-power mode circuitry to extend operational life. A secure communication module may support wired and wireless connectivity, such as Bluetooth, Wi-Fi, and Ethernet, while implementing encryption and authentication protocols to ensure data security.

The device may feature a versatile mounting mechanism, allowing it to be attached to various surfaces using spikes, augers, bolts, adhesives, or other methods. It may be designed for deployment by humans, machines, or unmanned systems, such as unmanned aerial vehicles (UAVs), and may include a structural housing that protects against environmental factors. Its compact, lightweight, and stackable design may facilitate portability and efficient deployment. By combining plasmonic and conventional communication technologies with secure, low-power operation and flexible deployment options, some implementations may address the limitations of existing solutions, providing a robust and cost-effective tool for establishing mesh networks in challenging conditions.

A communication device is described. The device may include a protective housing integrating a plasmonic antenna, a conventional antenna, a power source, and a mounting mechanism. The plasmonic antenna may be configured to couple electromagnetic signals to surface electromagnetic waves. The conventional antenna may be configured to enable compatibility with standard communication systems, wherein the plasmonic antenna and the conventional antenna may operate in conjunction to support a mesh network. The power source may be integrated with the communication device to support operation of the plasmonic antenna and the conventional antenna. The mounting mechanism may be configured for one or both of manual deployment or automated deployment by a robotic vehicle.

A method of forming a communication device is described. The method may include integrating a protective housing with a plasmonic antenna, a conventional antenna, a power source, and a mounting mechanism. The method may include configuring the plasmonic antenna to couple electromagnetic signals to surface electromagnetic waves. The method may include configuring the conventional antenna to enable compatibility with standard communication systems, wherein the plasmonic antenna and the conventional antenna may be operatively arranged to support a mesh network. The method may include integrating the power source to support operation of the plasmonic antenna and the conventional antenna. The method may include configuring the mounting mechanism for one or both of manual deployment or automated deployment by a robotic vehicle.

Some examples of the technologies and related methods described herein may further include a user interface integrated into the protective housing. The user interface may be configured to enable local configuration and monitoring of the communication device.

In some examples of the technologies and related methods described herein, the mounting mechanism may include a spike, auger, bolt, or adhesive. The mounting mechanism may be configured to secure the communication device to a surface in a dense forest or remote terrain.

Some examples of the technologies and related methods described herein may further include a cybersecurity module integrated into the protective housing. The cybersecurity module may be configured to implement encryption and authentication protocols for secure communication within the mesh network.

In some examples of the technologies and related methods described herein, the power source may include a solar panel, a battery, or an external power connector. The power source may be configured to support operation of the communication device in remote terrain.

In some examples of the technologies and related methods described herein, the mounting mechanism may be configured for UAV deployment or UGV deployment. The mounting mechanism may further be configured to enable installation of the communication device on varied surfaces.

In some examples of the technologies and related methods described herein, the protective housing may be stackable. The protective housing may be configured to facilitate efficient transport and deployment of multiple communication devices and equipment.

In some examples of the technologies and related methods described herein, the plasmonic antenna may be positioned within the protective housing to maximize coupling efficiency with electromagnetic signals propagating along a surface in remote terrain.

In some examples of the technologies and related methods described herein, the mounting mechanism may be configured to enable attachment of the communication device to surfaces using manual tools or automated systems.

In some examples of the technologies and related methods described herein, the cybersecurity module may be configured to prevent unauthorized access to communication devices and equipment by implementing multi-factor authentication protocols.

In some examples of the technologies and related methods described herein, the user interface may be configured to provide remote access to operational settings of the communication device through a mesh network.

In some examples of the technologies and related methods described herein, the power source may be configured to operate in low-power mode in response to periods of inactivity to extend the operational life of the communication device.

A method for using devices with plasmonic and conventional antennas for adaptable mesh network communication is described. The method may include receiving data signals from a device including a plasmonic antenna configured to couple electromagnetic signals to surface electromagnetic waves and a conventional antenna configured for compatibility with standard communication systems. The method may include processing the received data signals to determine network routing parameters. The method may include transmitting instructions to the device for establishing mesh network communication in response to the determined network routing parameters. The method may include managing secure data transmission within the mesh network by applying encryption and authentication protocols to the transmitted instructions.

A system configured for using devices with plasmonic and conventional antennas for adaptable mesh network communication is described. The system may include a processor and memory coupled with the processor. The memory may store instructions executable by the processor to cause the system to receive data signals from a device that may include a plasmonic antenna configured to couple electromagnetic signals to surface electromagnetic waves and a conventional antenna configured for compatibility with standard communication systems. The system may process the received data signals to determine network routing parameters. The system may transmit instructions to the device for establishing mesh network communication in response to the determined network routing parameters. The system may manage secure data transmission within the mesh network by applying encryption and authentication protocols to the transmitted instructions.

### BRIEF DESCRIPTION OF THE DRAWINGS

FIG. 1 is a block diagram illustrating an overview of an environment in which some implementations of the disclosed technology can operate.

FIG. 2 shows a communication network which supports techniques for attritable device with plasmonic antennas for mesh network communication and versatile deployment in accordance with various aspects of the present disclosure.

FIG. 3 shows a communications device which supports techniques for attritable device with plasmonic antennas for mesh network communication and versatile deployment in accordance with various aspects of the present disclosure.

FIG. 4 shows deployment scenarios which supports techniques for attritable device with plasmonic antennas for mesh network communication and versatile deployment in accordance with various aspects of the present disclosure.

FIG. 5 shows a block diagram of an apparatus that supports attritable device with plasmonic antennas for mesh network communication and versatile deployment in accordance with various aspects of the present disclosure.

FIG. 6 shows a block diagram of a mesh network communication component that supports attritable device with plasmonic antennas for mesh network communication and versatile deployment in accordance with various aspects of the present disclosure.

FIG. 7 shows a diagram of a system including a device that supports attritable device with plasmonic antennas for mesh network communication and versatile deployment in accordance with various aspects of the present disclosure.

FIGS. 8 and 9 show flowcharts illustrating methods that support attritable device with plasmonic antennas for mesh network communication and versatile deployment in accordance with various aspects of the present disclosure.

### DETAILED DESCRIPTION

Devices, apparatuses, systems, and methods that support techniques for attritable device with plasmonic antennas for mesh network communication and versatile deployment are disclosed. In some examples, existing communication devices may face several challenges in establishing reliable and adaptable networks in diverse and resource-constrained environments. Conventional antennas may be limited in range and efficiency, particularly in environments with physical obstructions or adverse conditions. High energy consumption may further restrict the operational life of these devices, while their lack of adaptability to different surfaces and terrains may complicate deployment. Additionally, many current solutions may be vulnerable to environmental factors such as moisture, temperature fluctuations, and physical impacts, reducing their reliability. The deployment process itself may often require significant manual effort or specialized systems, making it impractical for dynamic or remote scenarios. Furthermore, existing devices may frequently lack secure communication protocols, leaving them susceptible to unauthorized access and data breaches. These limitations may highlight the need for a portable, cost-effective, and resilient communication device that may address these shortcomings while enabling secure and efficient mesh network capabilities.

According to some implementations, communication devices may be configured to enable adaptable and resilient mesh networks in various environments. These devices may integrate advanced communication technologies, including a plasmonic antenna and a conventional antenna. The plasmonic antenna may be designed to couple electromagnetic signals to surface electromagnetic waves, which may be waves that travel along the surface to which the device is attached. The conventional antenna may provide compatibility with standard radio frequency systems, allowing the device to communicate using widely used methods.

Some implementations may include a modular power source that may provide energy to the device. The power source may include options such as a solar panel, a battery, or an external power connector. The device may incorporate circuitry that may reduce energy consumption during periods of inactivity, which may extend the operational life of the device.

The device may include a communication module that may support various wired and wireless communication methods, such as Bluetooth, Wireless Fidelity, Ethernet, or other protocols. This module may allow the device to transmit and receive data within the mesh network and may enable remote configuration and monitoring. The communication module may be connected to a control unit, which may include a processor and memory. The control unit may manage the operation of the device, including processing signals, routing data within the network, and interacting with other devices in the mesh network.

Some implementations may include a cybersecurity module that may prevent unauthorized access and may ensure secure communication within the mesh network. This module may use encryption and authentication protocols to protect transmitted data and device settings.

The device may include a mounting mechanism that may allow it to be secured to various surfaces. The mounting mechanism may include options such as a spike, auger, bolt, adhesive, or other attachment methods. This mechanism may enable the device to be deployed on surfaces such as walls, floors, equipment, vehicles, or natural terrain. The mounting mechanism may be compatible with manual installation by a human operator or automated deployment by a machine or unmanned system, such as an unmanned aerial vehicle.

Some implementations may include a user interface that may provide access for operators. The user interface may allow operators to configure the device locally and monitor its status and functionality.

The device may include a structural housing that may protect its internal components from environmental factors, such as impacts, moisture, and temperature variations. The housing may be compact and lightweight, which may facilitate portability and ease of deployment. The device may be stackable, which may allow multiple units to be carried and deployed efficiently.

Some implementations may include a deployment mechanism that may facilitate installation in various scenarios. This mechanism may include options such as a rack, harness, backpack, or parachute attachment. These options may enable deployment by humans, drones, or other systems. The parachute attachment may allow the device to be safely deployed from elevated platforms, such as aircraft, helicopters, or unmanned aerial vehicles.

The device may be designed to be low cost and may therefore be disposable or attritable. It may serve as a node in a mesh network that uses surface electromagnetic waves or as a repeater to extend communication range. The device may offer enhanced stealth characteristics by using surface electromagnetic wave communications along the surface to which it is attached. It may be configurable remotely via a network, such as any mesh network created by this and other similar devices. The device may be attached as a permanent or semi-permanent payload onto an unmanned aerial vehicle, which may enable mobile mesh networks in varied environments that may offer enhanced resiliency and adaptability.

Aspects of the subject matter described in this disclosure can be implemented to realize one or more of the following potential advantages. The described techniques may be implemented to support rapid and scalable deployment of communication networks in environments where traditional infrastructure may be impractical or unavailable. The device may enable seamless integration with existing communication systems while maintaining compatibility with emerging technologies. Its design may allow for operation in resource-constrained settings, where energy efficiency and durability may be critical. The modularity of the components may facilitate customization for specific use cases, such as temporary installations or long-term deployments. The device may enhance operational flexibility by supporting various deployment methods, including manual, automated, or aerial placement, which may reduce the time and effort required for installation.

Aspects of the disclosure are initially described in the context of communication devices. Aspects of the disclosure are additionally illustrated by and described with reference to example implementations. Aspects of the disclosure are further illustrated by and described with reference to a flowchart that relates to methods involving attritable device with plasmonic antennas for mesh network communication and versatile deployment.

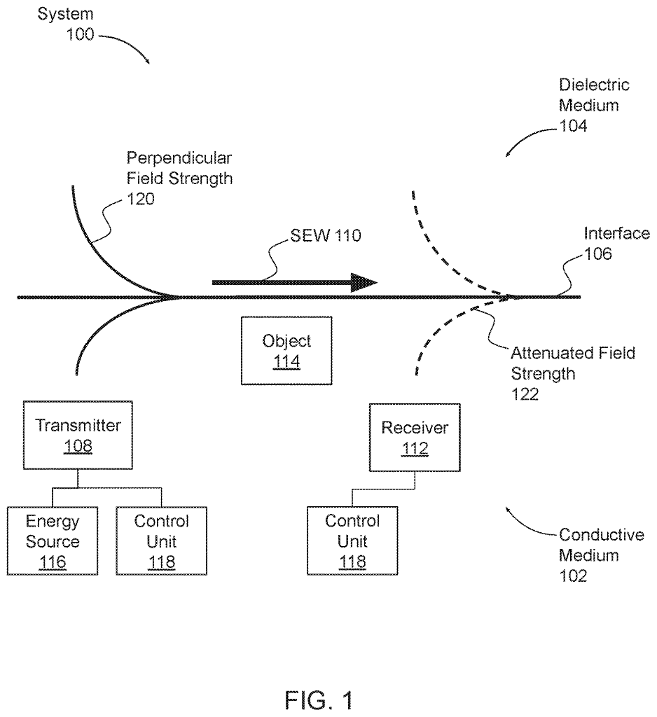

FIG. 1 illustrates a system 100 that demonstrates the concept of surface electromagnetic waves (SEWs), in accordance with one or more implementations. The system 100 may include a conductive medium 102, such as a body of water, organic tissue, a metallic plane, and/or other conductive media. Adjacent to the conductive medium 102, there may be a dielectric medium 104, such as air and/or other dielectric media, which may interface with the conductive medium 102. The interface 106 between the conductive medium 102 and the dielectric medium 104 may be where SEWs are generated and may propagate.

The system 100 may also include a transmitter 108, which may be positioned near the interface 106. The transmitter 108 may be positioned within the conductive medium 102 or within the dielectric medium 104. The transmitter 108 may be responsible for generating an electromagnetic field that may induce SEWs at the interface 106 of the conductive medium 102 and the dielectric medium 104. The excited SEWs may then travel along the interface 106, as indicated by the arrow of SEW 110, which may represent the direction of wave propagation.

To help visualize the phenomenon of SEWs, one may consider an analogy to ripples on a pond. When a stone is dropped into a still pond, ripples may form and spread out across the surface of the water. Similarly, the transmitter 108 may be thought of as the stone, and the SEWs may be akin to the ripples that spread along the conductive medium 102. Just as the ripples may move outward from the point of impact, SEWs may propagate along the interface 106, carrying energy with them.

The system 100 may further include a receiver 112, which may be positioned at a distance from the transmitter 108 along the interface 106. The receiver 112 may be positioned within the conductive medium 102 or within the dielectric medium 104. The receiver 112 may be configured to receive the SEWs after they have propagated along the interface 106. This may be analogous to placing one's hand in the water at a distance from where the stone was dropped, feeling the ripples as they pass by.

Additionally, the system 100 may include an object 114 positioned within the conductive medium 102 or within the dielectric medium 104, which may be representative of an obstacle that SEWs may encounter during propagation. The interaction of SEWs with the object 114 may lead to scattering of waves, similar to how water ripples may change direction or form patterns when they encounter a leaf or a rock in the pond.

The system 100 may include an energy source 116, such as a radio frequency generator, which may be connected to the transmitter 108. The energy source 116 may provide the necessary power for the transmitter 108 to generate the electromagnetic fields that excite the SEWs. This may be thought of as the force with which the stone is thrown into the pond, affecting the size and strength of the resulting ripples.

In some implementations, the system 100 may include a control unit 118, which may be operatively coupled to the transmitter 108 and/or the receiver 112. The control unit 118 may be responsible for coordinating the generation and detection of SEWs, much like a person orchestrating the timing of stones being dropped into the pond to create a specific pattern of ripples.

From a more technical perspective, SEWs may be understood as a type of wave that propagates along the interface between two media with different dielectric properties. In FIG. 1, the conductive medium 102 and the dielectric medium 104 may form such an interface (e.g., interface 106) where SEWs may be excited and propagate. The transmitter 108 may serve as a transducer that converts electrical signals from the energy source 116 into electromagnetic fields, which may then couple to the interface 106 and give rise to SEWs.

The propagation of SEWs along the interface 106 may be characterized by a wave vector that is parallel to the interface 106. This wave vector may be larger than the wave vector of free photons in the dielectric medium 104, which may result in a confinement of the electromagnetic field to the vicinity of the interface 106. The SEW's field strength may decay exponentially in the direction perpendicular to the interface 106, as illustrated by a field strength 120 extending into the dielectric medium 104 and the conductive medium 102. These field strengths may also decay as the SEW propagates along the interface 106, as illustrated by an attenuated field strength 122. The receiver 112 may be designed to couple to these confined, attenuated fields and receive the SEWs after they have propagated along the interface 106.

The excitation of SEWs by the transmitter 108 may involve the conversion of the electromagnetic energy into a surface-bound mode, which may be facilitated by the specific design of the transmitter 108. The transmitter 108 may be optimized to match the impedance of the SEWs to maximize energy transfer into the surface wave mode. The object 114 submerged within the conductive medium 102 may introduce perturbations in the SEWs, which may be detected by the receiver 112 and analyzed by the control unit 118 to infer properties of the object 114. Examples of such properties may include one or more of size, shape, location, material properties, and/or other properties.

The mathematical description of SEWs may be derived from Maxwell's equations, which govern the properties of electromagnetic fields. The wave equation for TM-polarized SEWs may be reduced to a one-dimensional Schrödinger equation:

$$\frac{{d}^{2} ψ}{d {z}^{2}} + ( {k}^{2} - V ( z ) ) ψ = 0 \qquad ( EQN . 1 )$$

where ψ is the effective wave function introduced as E_{z}=ψ/\sqrt{ε}, and V(z) is the effective potential energy that guides the propagation of SEWs along the interface. The term k² may represent the total energy of the SEWs and the term e may represent the dielectric permittivity of the medium.

For TE-polarized SEWs, the wave equation may not depend on the gradient term V(z) and may be expressed as:

$$\frac{{d}^{2} {E}_{z}}{d {z}^{2}} + {k}^{2} {E}_{z} = 0 \qquad ( EQN . 2 )$$

In the case of a sharp interface between two media with dielectric permittivities ε₁ and ε₂, the SEW wave vector for TM-polarized waves may be given by:

$${k}_{SEW} = \sqrt{\frac{{ω}^{2}}{{c}^{2}} \frac{{ϵ}_{1} {ϵ}_{2}}{{ϵ}_{1} + {ϵ}_{2}}} \qquad ( EQN . 3 )$$

where ω is the angular frequency of the SEWs, and c is the speed of light in vacuum.

The presence of dielectric permittivity gradients across the interface 106 may lead to additional terms in the effective potential V_{z}, which may result in the formation of a potential well that supports bound states of SEWs. These bound states may correspond to surface modes with long propagation lengths and may be excited by the transmitter 108 with appropriate impedance matching.

The system 100 may thus utilize SEWs for various applications, including communication and sensing, by exploiting the unique properties of SEWs at the interface 106 between the conductive medium 102 and the dielectric medium 104. The control unit 118 may process the received signals to extract information about the propagation and interaction of SEWs with the environment and objects within it.

In some implementations, the transmitter 108 and/or the receiver 112 may include one or more plasmonic antennas. A given plasmonic antenna may be the same as or similar to, or include one or more aspects of, the antennas disclosed in U.S. patent application Ser. No. 17/570,968 entitled “Apparatus, Methods and Systems for Electromagnetic Signal Transmission Through a Conductive Medium” filed on Jan. 7, 2022; International Application No. PCT/US2024/061379 entitled “Surface Electromagnetic Wave Antenna” filed on Dec. 20, 2024; International Patent Application No. PCT/US2025/015358 entitled “Hybrid Antenna With Dynamic Signal Routing For Free-Space And Near-Metal Environments” filed on Feb. 11, 2025; International Patent Application No. PCT/US2025/020593 entitled “Detection Of Objects Behind Metal Barriers Using Plasmonic Antennas” filed on Mar. 19, 2025; and U.S. Pat. No. 12,267,114 entitled “Apparatus, Methods And Systems For Surface Electromagnetic Wave (SEW)-Based Underwater And Underground Communication And Imaging” filed on Jan. 7, 2022; of which the entirety is incorporated by reference for all purposes.

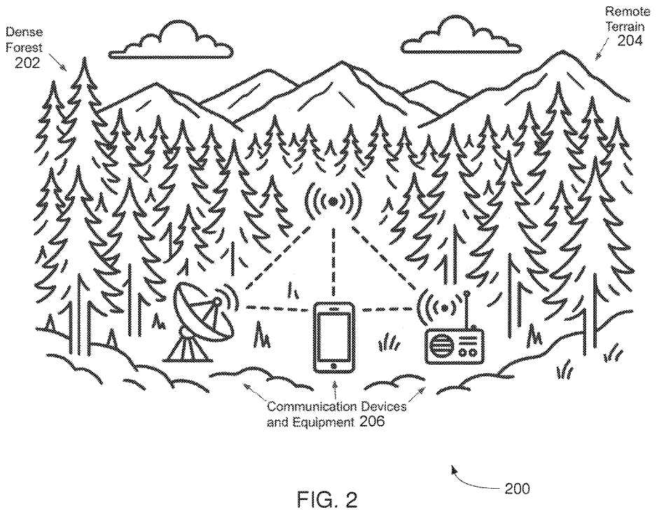

FIG. 2 shows communication network 200 which supports techniques for attritable device with plasmonic antennas for mesh network communication and versatile deployment in accordance with various aspects of the present disclosure. As depicted in FIG. 2, the communication network 200 may include one or more of a dense forest 202, a remote terrain 204, communication devices and equipment 206, and/or other components.

The dense forest 202 may include various natural obstacles that impact communication signal propagation. The dense forest 202 may include thick vegetation, uneven terrain, and other physical barriers that may interfere with the transmission of electromagnetic signals. The dense forest 202 may create conditions where conventional communication devices may experience signal attenuation or reflection. In some implementations, the dense forest 202 may include alternative environments such as jungles or urban areas.

The remote terrain 204 may represent an environment with challenging geographical features for network deployment. The remote terrain 204 may include rocky landscapes, steep inclines, or isolated regions that may complicate the placement of communication devices. In some implementations, the remote terrain 204 may include deserts, mountainous regions, or arctic environments.

The communication devices and equipment 206 may provide connectivity options for establishing mesh networks in diverse conditions. In some implementations, the communication devices and equipment 206 may include a satellite dish, a smartphone, a radio, and/or other devices and equipment used in communications.

The satellite dish may support long-range communication capabilities for network integration. The satellite dish may include a parabolic reflector and a feed horn that may focus and transmit signals to and from satellites. The satellite dish may interact with network infrastructure to enable integration with broader communication systems. The satellite dish may be positioned in areas with a clear line of sight to the sky to maximize signal reception. In some implementations, the satellite dish may include portable or fixed installations for use in remote or urban environments.

The smartphone may include functionality for interacting with mesh network nodes and monitoring device status. The smartphone may include a touchscreen interface, wireless communication modules, and software applications that may allow users to configure and monitor network devices. The smartphone may interact with communication apparatuses to send and receive data within the mesh network. The smartphone may include compatibility with Bluetooth, Wi-Fi, or other wireless protocols to connect with nearby devices.

The radio may provide compatibility with standard communication protocols for versatile deployment scenarios. The radio may include a transmitter, receiver, and antenna that may operate on various frequency bands. The radio may interact with conventional antennas to enable communication with existing radio systems. The radio may include features such as frequency hopping or encryption to support secure and reliable communication. In some implementations, the radio may include handheld, vehicle-mounted, or stationary configurations.

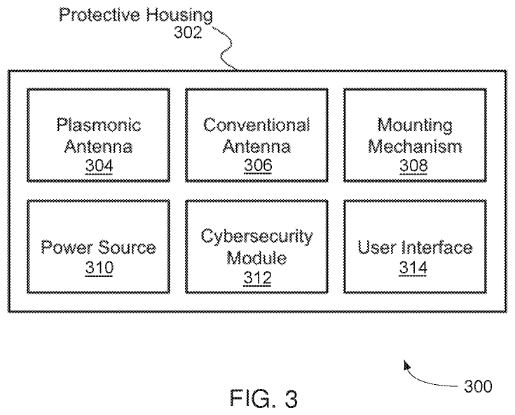

FIG. 3 shows a communications device 300 which supports techniques for attritable device with plasmonic antennas for mesh network communication and versatile deployment in accordance with various aspects of the present disclosure. As depicted in FIG. 3, the communications device 300 may include one or more of a protective housing 302, a plasmonic antenna 304, a conventional antenna 306, a mounting mechanism 308, a power source 310, a cybersecurity module 312, a user interface 314, and/or other components.

The protective housing 302 may include materials designed to shield internal components from environmental factors. The materials may include impact-resistant polymers, corrosion-resistant metals, or weatherproof coatings. The protective housing 302 may be designed to withstand physical impacts, moisture, and temperature variations. The housing may be integrated with other components, such as the mounting mechanism 308, to ensure structural stability. In some implementations, the housing may include modular designs to accommodate different deployment scenarios or environmental conditions.

The plasmonic antenna 304 may include configurations to couple electromagnetic signals to surface electromagnetic waves. In some implementations, the plasmonic antenna 304 may be integrated into communication apparatuses for compact designs. The plasmonic antenna 304 may coexist with the conventional antenna 306 to support hybrid communication systems. In some implementations, the plasmonic antenna 304 may be the same as or similar to, or include one or more aspects of, the transmitter 108 and/or the receiver 112, as described herein.

The conventional antenna 306 may include features to support compatibility with standard communication systems. The conventional antenna 306 may provide compatibility with standard radio frequency communication systems. In some implementations, the conventional antenna 306 may include dipole or monopole designs for broad coverage. The conventional antenna 306 may connect to signal transmission devices to relay signals across established networks. In some implementations, the conventional antenna 306 may be mounted using the versatile mounting mechanism 308 for stability. The conventional antenna 306 may operate alongside the plasmonic antenna 306 to address diverse communication requirements.

The mounting mechanism 308 may include structures to secure the device to various surfaces. The structures may include spikes, augers, bolts, adhesives, or other attachment methods. The mounting mechanism 308 may be designed to allow manual installation by a human operator or automated deployment by a robotic vehicle. The mechanism may be compatible with diverse surfaces, such as walls, floors, or natural terrain. In some implementations, the mounting mechanism 308 may include detachable or adjustable components to adapt to specific deployment needs.

The power source 310 may include options such as solar panels, batteries, or external power connectors. The power source 310 may be modular, allowing for easy replacement or reconfiguration based on operational requirements. The power source 310 may be integrated with low-power mode circuitry to reduce energy consumption during periods of inactivity. In some implementations, the power source 310 may include hybrid configurations that combine multiple energy sources for extended operational life.

The cybersecurity module 312 may include encryption and authentication protocols to secure data transmission. The cybersecurity module 312 may implement advanced cryptographic algorithms to protect communication within the mesh network. The cybersecurity module 312 may be configured to manage secure access and data integrity. In some implementations, the cybersecurity module 312 may include hardware-based security features to prevent tampering or unauthorized modifications.

The user interface 314 may include controls for local configuration and monitoring of the communications device 300. The user interface 314 may include physical buttons, touchscreens, or other input methods. The user interface 314 may display operational status, network connectivity, and other relevant information. In some implementations, the user interface 314 may include wireless connectivity options, such as Bluetooth, to enable remote configuration by an operator.

In some implementations, the protective housing 302 may encase the plasmonic antenna 304, conventional antenna 306, mounting mechanism 308, power source 310, cybersecurity module 312, and user interface 314. The plasmonic antenna 304 may be positioned within the housing 302 to maximize coupling efficiency with the surrounding environment. The conventional antenna 306 may be arranged adjacent to the plasmonic antenna 304 to ensure compatibility with standard radio frequency systems. The mounting mechanism 308 may be integrated into the housing 302 to allow secure attachment to various surfaces. The power source 310 may be connected to the plasmonic antenna 304, conventional antenna 306, and other components to provide necessary power for operation. The cybersecurity module 312 may prevent unauthorized access. The user interface 314 may be accessible from the exterior of the housing 302 to allow operators to configure and monitor the device's status and functionality.

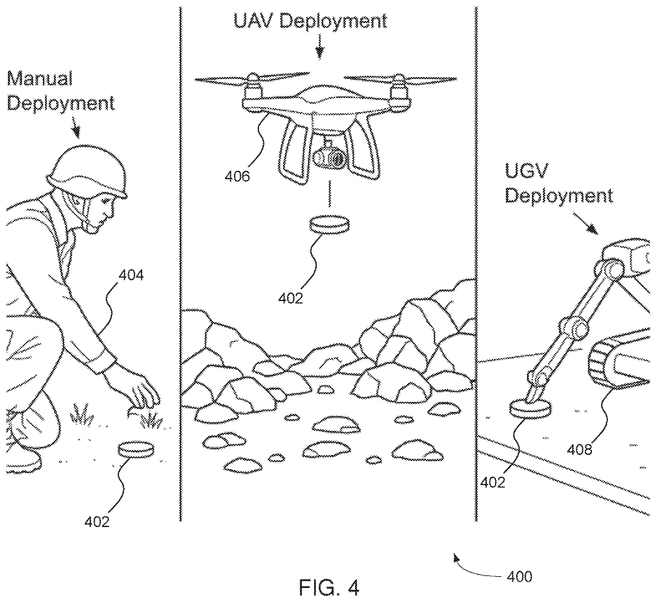

FIG. 4 shows deployment scenarios 400 which supports techniques for attritable device with plasmonic antennas for mesh network communication and versatile deployment in accordance with various aspects of the present disclosure. As depicted in FIG. 4, the deployment scenarios 400 may include one or more of an attritable puck 402, a human operator 404, a UAV 406, a UGV 408, and/or other components.

The attritable puck 402 may include a compact and lightweight design suitable for deployment in various environments. The attritable puck 402 may be designed to be small and human-portable, making it easy to carry and deploy. The device may incorporate a protective housing 302 that shields its internal components from environmental factors such as physical impacts, moisture, and temperature variations. The attritable puck 402 may be stackable, allowing multiple units to be carried and deployed efficiently. In some implementations, the attritable puck 402 may be equipped with a mounting mechanism 308 that enables it to be secured to various surfaces, such as walls, floors, or natural terrain.

The human operator 404 may represent a manual deployment method for placing the attritable puck 402 on different surfaces. The human operator 404 may use various tools and techniques to secure the device, such as screwing, drilling, pushing, or hammering the mounting mechanism 308 into the surface. The human operator 404 may configure the device locally using a user interface 314 integrated into the attritable puck 402. In some implementations, the human operator 404 may carry multiple attritable pucks 402 in a harness or backpack for deployment over a wide area.

The UAV 406 may include capabilities for automated deployment of the attritable puck 402 in remote or elevated locations. The UAV 406 may be equipped with a mechanism to release the attritable puck 402 from an elevated position, such as a parachute attachment for safe descent. The UAV 406 may deploy the device on surfaces that are difficult to reach manually, such as rooftops or dense forest 202 canopies. In some implementations, the UAV 406 may communicate with the attritable puck 402 via Bluetooth or Wi-Fi to configure and monitor the device remotely.

The UGV 408 may include mechanisms for ground-based deployment of the attritable puck 402 across diverse terrains. The UGV 408 may be equipped with an arm or other attachment to place the attritable puck 402 on the ground or other surfaces. The UGV 408 may navigate through challenging environments, such as remote terrain 204, to deploy the device where human access is limited. In some implementations, the UGV 408 may be configured to deploy multiple attritable pucks 402 in a single mission, enhancing the coverage of the mesh network.

In some implementations, the attritable puck 402 may be positioned on various surfaces by the human operator 404, the UAV 406, or the UGV 408, depending on the deployment scenario. The human operator 404 may manually place the attritable puck 402 on terrain such as soil or rock, ensuring contact with the surface for effective operation. The UAV 406 may release the attritable puck 402 from an elevated position, allowing it to descend and settle onto the intended surface. The UGV 408 may deploy the attritable puck 402 by extending its robotic arm to place the device securely on a designated area.

In some implementations, the attritable puck 402 may incorporate internal components that interact with external deployment systems. The modular power source within the attritable puck 402 may activate upon placement, supplying energy to the plasmonic antenna and conventional antenna for communication purposes. The control unit within the attritable puck 402 may coordinate signal processing and network routing, enabling interaction with other devices in the mesh network. The mounting mechanism of the attritable puck 402 may adapt to the surface characteristics encountered during deployment by the human operator 404, UAV 406, or UGV 408.

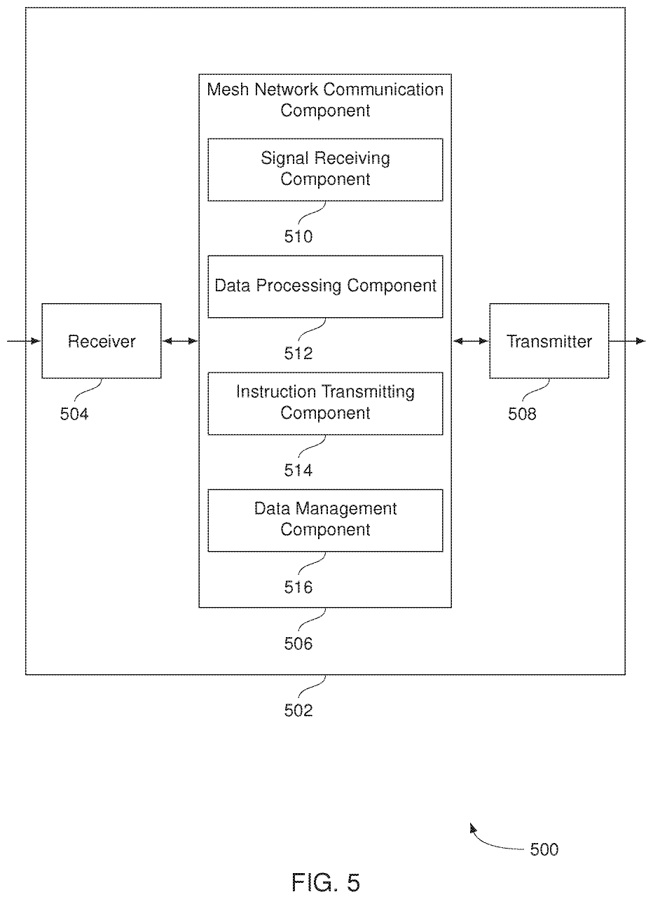

FIG. 5 shows a block diagram 500 of an apparatus 502 that supports attritable device with plasmonic antennas for mesh network communication and versatile deployment in accordance with various aspects of the present disclosure. The apparatus 502 may be the same as or similar to one or more components described in connection with the environment 100 of FIG. 1. The apparatus 502 may include an input module 504, mesh network communication component 506, and an output module 508. The apparatus 502 may also include a processor. Each of these components may be in communication with one another (e.g., via one or more buses). In some cases, the apparatus 502 may be an example of a user terminal, a database server, or a system containing multiple computing devices.

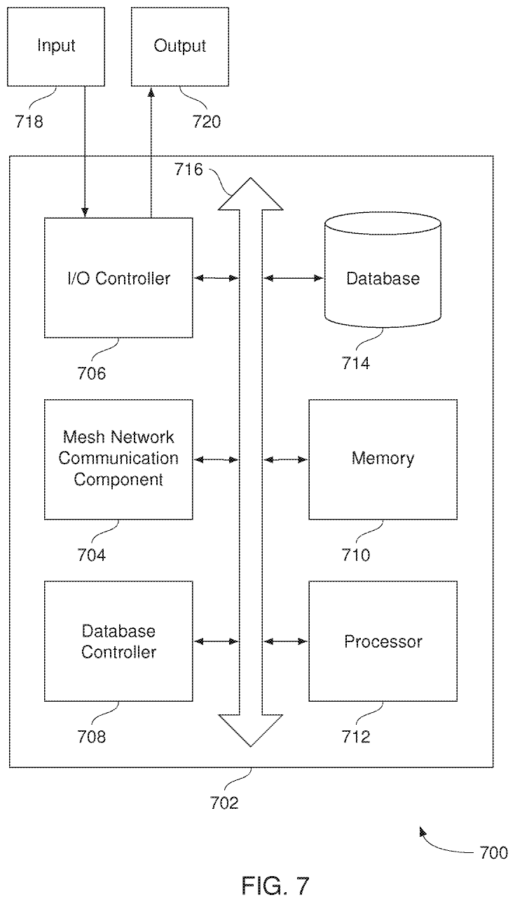

The input module 504 may manage input signals for the apparatus 502. For example, the input module 504 may identify input signals based on an interaction with a modem, a keyboard, a mouse, a touchscreen, or a similar device. These input signals may be associated with user input or processing at other components or devices. In some cases, the input module 504 may utilize an operating system such as iOS®, ANDROID®, MS-DOS®, MS-WINDOWS®, OS/2®, UNIX®, LINUX®, or another known operating system to handle input signals. The input module 504 may send aspects of these input signals to other components of the apparatus 502 for processing. In some cases, the input module 504 may be a component of an input/output (I/O) controller 706 as described with reference to FIG. 7.

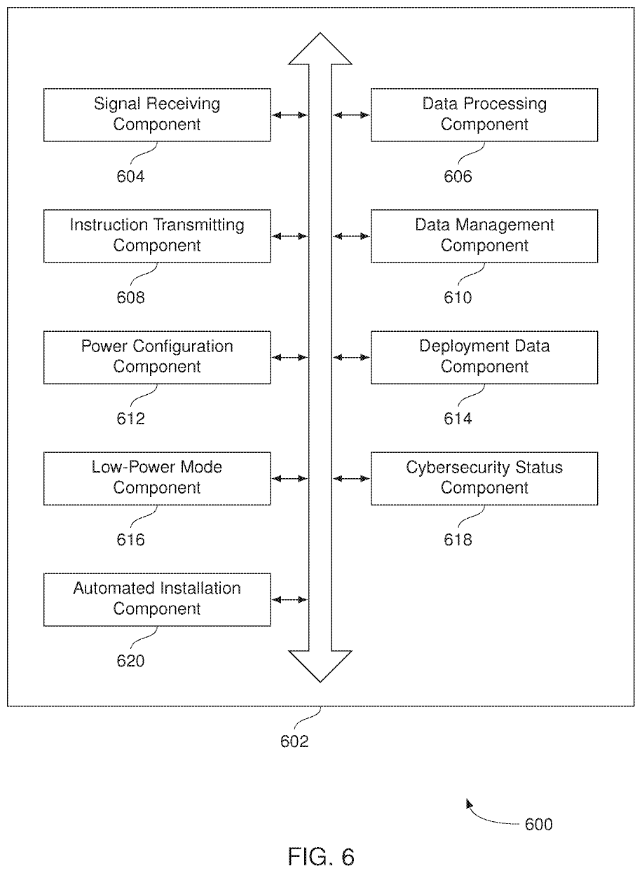

The mesh network communication component 506 may include one or more of a signal receiving component 510, a data processing component 512, an instruction transmitting component 514, a data management component 516, and/or other components. The mesh network communication component 506 may be an example of aspects of the mesh network communication component 602 or 704 described with reference to FIGS. 6 and 7.

The signal receiving component 510 may be configured as or otherwise support a means for receiving data signals from a device including a plasmonic antenna configured to couple electromagnetic signals to surface electromagnetic waves and a conventional antenna configured for compatibility with standard communication systems. The data processing component 512 may be configured as or otherwise support a means for processing the received data signals to determine network routing parameters. The instruction transmitting component 514 may be configured as or otherwise support a means for transmitting instructions to the device for establishing mesh network communication in response to the determined network routing parameters. The data management component 516 may be configured as or otherwise support a means for managing secure data transmission within the mesh network by applying encryption and authentication protocols to the transmitted instructions.

The output module 508 may manage output signals for the apparatus 502. For example, the output module 508 may receive signals from other components of the apparatus 502, such as the mesh network communication component 506, and may transmit these signals to other components or devices. In some specific examples, the output module 508 may transmit output signals for display in a user interface, for storage in a database or data store, for further processing at a server or server cluster, or for any other processes at any number of devices or systems. In some cases, the output module 508 may be a component of an I/O controller 706 as described with reference to FIG. 7.

FIG. 6 shows a block diagram 600 of a mesh network communication component 602 that supports attritable device with plasmonic antennas for mesh network communication and versatile deployment in accordance with various aspects of the present disclosure. The mesh network communication component 602 may be an example of aspects of a mesh network communication component 506, a mesh network communication component 704, or both, as described herein. The mesh network communication component 602, or various components thereof, may be an example of means for performing various aspects of attritable device with plasmonic antennas for mesh network communication and versatile deployment as described herein. For example, the mesh network communication component 602 may include one or more of a signal receiving component 604, a data processing component 606, an instruction transmitting component 608, a data management component 610, a power configuration component 612, a deployment data component 614, a low-power mode component 616, a cybersecurity status component 618, an automated installation component 620, and/or other components. Each of these components may communicate, directly or indirectly, with one another (e.g., via one or more buses).

The signal receiving component 604 may be configured as or otherwise support a means for receiving data signals from a device including a plasmonic antenna that may be configured to couple electromagnetic signals to surface electromagnetic waves and a conventional antenna that may be configured for compatibility with standard communication systems. In some implementations, the signal receiving component 604 may include circuitry that may be adaptable to varying signal frequencies to accommodate diverse communication protocols. The signal receiving component 604 may incorporate shielding materials that may reduce interference from external electromagnetic sources during operation.

The plasmonic antenna may be positioned to interact with specific surface geometries that may enhance signal coupling efficiency in certain environments. In some implementations, the plasmonic antenna may include adjustable elements that may allow for tuning to specific surface wave propagation characteristics. The conventional antenna may be designed with modular components that may allow for replacement or reconfiguration to support different communication standards.

The data processing component 606 may be configured as or otherwise support a means for processing the received data signals to determine network routing parameters. In some implementations, the data processing component 606 may include algorithms that may analyze signal strength variations to determine routing paths. In some implementations, the data processing component 606 may incorporate machine learning models that may adapt routing parameters based on historical communication patterns. In some implementations, the data processing component 606 may utilize error-checking protocols that may identify and address inconsistencies in received data signals.

The instruction transmitting component 608 may be configured as or otherwise support a means for transmitting instructions to the device for establishing mesh network communication in response to the determined network routing parameters. In some implementations, the instruction transmitting component 608 may include circuitry that may adapt to varying communication protocols to accommodate different device configurations. In some implementations, the instruction transmitting component 608 may incorporate signal amplification features that may enhance the transmission range in environments with physical obstructions. In some implementations, the instruction transmitting component 608 may utilize frequency modulation techniques that may reduce interference during instruction transmission.

The data management component 610 may be configured as or otherwise support a means for managing secure data transmission within the mesh network by applying encryption and authentication protocols to the transmitted instructions. In some implementations, the data management component 610 may incorporate symmetric encryption methods that may allow for secure communication between devices with pre-shared keys. In some implementations, the data management component 610 may support asymmetric encryption techniques that may enable secure key exchanges over untrusted channels. In some implementations, the data management component 610 may include multi-factor authentication protocols that may require multiple verification steps before granting access to transmitted instructions. In some implementations, the data management component 610 may utilize time-based authentication tokens that may periodically refresh to reduce the risk of unauthorized access.

In some examples, the power configuration component 612 may be configured as or otherwise support a means for transmitting configuration instructions to the device for activating a modular power source selected from solar panels, batteries, or external power connectors in response to detected environmental conditions. In some implementations, the power configuration component 612 may include sensors that may detect light intensity to determine the suitability of solar panels. In some implementations, the power configuration component 612 may monitor battery levels to decide when to switch to an external power connector. In some implementations, the power configuration component 612 may incorporate temperature sensors that may influence the choice of power source based on environmental heat. In some implementations, the power configuration component 612 may evaluate humidity levels to assess the reliability of different power sources. In some implementations, the power configuration component 612 may use wind speed data to determine the feasibility of using wind-powered generators as an alternative power source.

In some examples, the deployment data component 614 may be configured as or otherwise support a means for receiving deployment data from the device indicating attachment to a surface via a mounting mechanism that may be selected from spikes, augers, bolts, adhesives, or other attachment methods. In some implementations, the deployment data component 614 may receive data indicating that the mounting mechanism may include a spike designed to penetrate soft soil or sand. In some implementations, the deployment data component 614 may process data showing that the mounting mechanism may involve an auger configured to secure the device to harder terrains such as compacted dirt or clay. In some implementations, the deployment data component 614 may interpret signals indicating that the mounting mechanism may include bolts designed for attachment to rigid surfaces such as concrete or metal. In some implementations, the deployment data component 614 may analyze deployment data showing that the mounting mechanism may involve adhesives formulated to bond with surfaces like glass, plastic, or wood. In some implementations, the deployment data component 614 may determine that the mounting mechanism may include other attachment methods, such as magnetic bases for metallic surfaces or suction cups for smooth, non-porous surfaces.

In some examples, the low-power mode component 616 may be configured as or otherwise support a means for transmitting control signals to the device for initiating low-power mode circuitry in response to periods of inactivity to extend operational life. In some implementations, the low-power mode component 616 may transmit control signals that may adjust the device's power consumption based on detected environmental conditions, such as temperature or humidity. In some implementations, the low-power mode component 616 may include sensors that may determine the duration of inactivity before initiating the low-power mode circuitry. In some implementations, the low-power mode component 616 may transmit control signals that may activate specific subsystems within the device to operate at reduced power levels during inactivity.

In some examples, the cybersecurity status component 618 may be configured as or otherwise support a means for receiving cybersecurity status updates from the device indicating encryption and authentication protocol activity for secure communication within the mesh network. In some implementations, the cybersecurity status component 618 may receive data indicating the activation of symmetric encryption protocols that may involve pre-shared keys between devices. In some implementations, the cybersecurity status component 618 may interpret signals showing the use of asymmetric encryption methods that may allow for secure key exchanges over untrusted channels. In some implementations, the cybersecurity status component 618 may process updates indicating the application of multi-factor authentication protocols that may require multiple verification steps for access. In some implementations, the cybersecurity status component 618 may determine the status of time-based authentication tokens that may periodically refresh to reduce the risk of unauthorized access.

In some examples, the automated installation component 620 may be configured as or otherwise support a means for transmitting deployment instructions to the device for automated installation by an unmanned system that may be selected from UAVs, robots, or other automated systems. In some implementations, the automated installation component 620 may transmit deployment instructions that may include specific coordinates for the unmanned system to position the device on a designated surface. In some implementations, the automated installation component 620 may transmit instructions that may specify the angle and depth at which the device may be secured to the surface. In some implementations, the automated installation component 620 may include parameters that may allow the unmanned system to adjust its deployment mechanism based on the material properties of the surface, such as hardness or texture. In some implementations, the automated installation component 620 may transmit data that may guide the unmanned system to avoid obstacles during the installation process. In some implementations, the automated installation component 620 may support communication protocols that may allow the unmanned system to confirm successful installation of the device.

FIG. 7 shows a diagram of a system 700 including a device 702 that supports attritable device with plasmonic antennas for mesh network communication and versatile deployment in accordance with aspects of the present disclosure. The device 702 may be an example of or include the components of a database server or an apparatus 502 as described herein. The device 702 may include components for bi-directional data communications including components for transmitting and receiving communications, including a mesh network communication component 704, an I/O controller 706, a database controller 708, memory 710, a processor 712, and a database 714. These components may be in electronic communication via one or more buses (e.g., bus 716).

The mesh network communication component 704 may be an example of a mesh network communication component 506 or 602 as described herein. For example, the mesh network communication component 704 may perform any of the methods or processes described above with reference to FIGS. 5 and 6. In some cases, the mesh network communication component 704 may be implemented in hardware, software executed by a processor, firmware, or any combination thereof.

The I/O controller 706 may manage input signals 718 and output signals 720 for the device 702. The I/O controller 706 may also manage peripherals not integrated into the device 702. In some cases, the I/O controller 706 may represent a physical connection or port to an external peripheral. In some cases, the I/O controller 706 may utilize an operating system such as iOS®, ANDROID®, MS-DOS®, MS-WINDOWS®, OS/2®, UNIX®, LINUX®, or another known operating system. In other cases, the I/O controller 706 may represent or interact with a modem, a keyboard, a mouse, a touchscreen, or a similar device. In some cases, the I/O controller 706 may be implemented as part of a processor. In some cases, a user may interact with the device 702 via the I/O controller 706 or via hardware components controlled by the I/O controller 706.

The database controller 708 may manage data storage and processing in a database 714. In some cases, a user may interact with the database controller 708. In other cases, the database controller 708 may operate automatically without user interaction. The database 714 may be an example of a single database, a distributed database, multiple distributed databases, a data store, a data lake, or an emergency backup database.

Memory 710 may include random-access memory (RAM) and read-only memory (ROM). The memory 710 may store computer-readable, computer-executable software including instructions that, when executed, cause the processor to perform various functions described herein. In some cases, the memory 710 may contain, among other things, a basic input/output system (BIOS) which may control basic hardware or software operation such as the interaction with peripheral components or devices.

The processor 712 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 712 may be configured to operate a memory array using a memory controller. In other cases, a memory controller may be integrated into the processor 712. The processor 712 may be configured to execute computer-readable instructions stored in a memory 710 to perform various functions (e.g., functions or tasks supporting attritable device with plasmonic antennas for mesh network communication and versatile deployment).

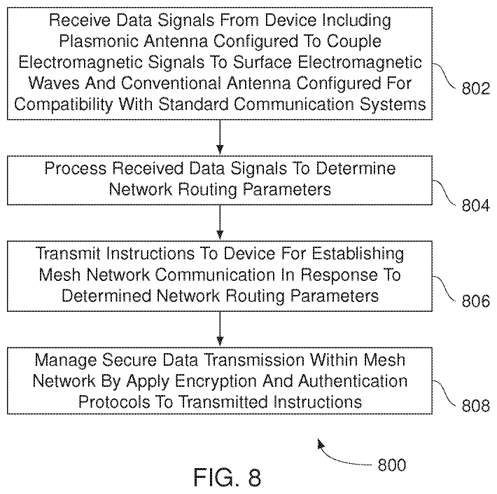

FIG. 8 shows a flowchart illustrating a method 800 that supports attritable device with plasmonic antennas for mesh network communication and versatile deployment in accordance with various aspects of the present disclosure. The operations of the methods described herein may be implemented by one or more of a device, an apparatus, a system (e.g., a networked computing system), and/or components thereof as described herein. For example, the operations of the method 800 may be performed by a mesh network communication component as described with reference to FIGS. 5 through 7. In some examples, one or more components of a device, apparatus, and/or system may execute a set of instructions to control the functional elements of the component(s) to perform the described functions. Additionally or alternatively, the one or more components of a device, apparatus, and/or system may perform aspects of the described functions using special-purpose hardware.

At 802, the method 800 may include receiving data signals from a device including a plasmonic antenna configured to couple electromagnetic signals to surface electromagnetic waves and a conventional antenna configured for compatibility with standard communication systems. The operations of 802 may be performed in accordance with examples as disclosed herein. In some examples, aspects of the operations of 802 may be performed by a signal receiving component 604 as described with reference to FIG. 6.

At 804, the method 800 may include processing the received data signals to determine network routing parameters. The operations of 804 may be performed in accordance with examples as disclosed herein. In some examples, aspects of the operations of 804 may be performed by a data processing component 606 as described with reference to FIG. 6.

At 806, the method 800 may include transmitting instructions to the device for establishing mesh network communication in response to the determined network routing parameters. The operations of 806 may be performed in accordance with examples as disclosed herein. In some examples, aspects of the operations of 806 may be performed by an instruction transmitting component 608 as described with reference to FIG. 6.

At 808, the method 800 may include managing secure data transmission within the mesh network by applying encryption and authentication protocols to the transmitted instructions. The operations of 808 may be performed in accordance with examples as disclosed herein. In some examples, aspects of the operations of 808 may be performed by a data management component 610 as described with reference to FIG. 6.

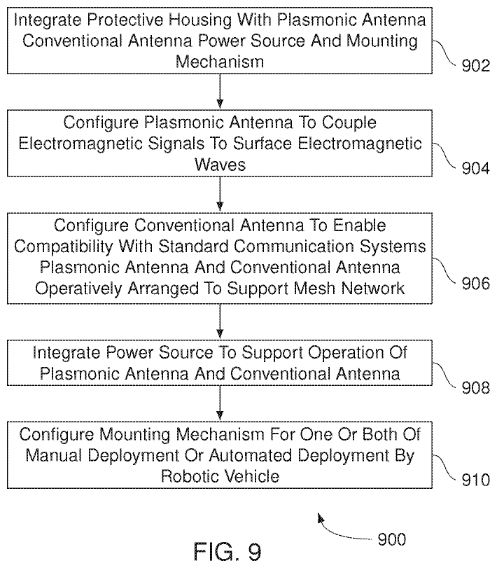

FIG. 9 shows a flowchart illustrating a method 900 involving communication devices in accordance with various aspects of the present disclosure.

At 902, the method 900 may include integrating a protective housing with a plasmonic antenna, a conventional antenna, a power source, and a mounting mechanism. The operations of 902 may be performed in accordance with examples as disclosed herein. In some examples, aspects of the operations of 902 may involve one or more of protective housing 302, plasmonic antenna 304, conventional antenna 306, power source 310, and mounting mechanism 308 as described with reference to FIG. 3.

At 904, the method 900 may include configuring the plasmonic antenna to couple electromagnetic signals to surface electromagnetic waves. The operations of 904 may be performed in accordance with examples as disclosed herein. In some examples, aspects of the operations of 904 may involve plasmonic antenna 304 as described with reference to FIG. 3.

At 906, the method 900 may include configuring the conventional antenna to enable compatibility with standard communication systems, wherein the plasmonic antenna and the conventional antenna are operatively arranged to support a mesh network. The operations of 906 may be performed in accordance with examples as disclosed herein. In some examples, aspects of the operations of 906 may involve conventional antenna 306 and plasmonic antenna 304 as described with reference to FIG. 3.

At 908, the method 900 may include integrating the power source to support operation of the plasmonic antenna and the conventional antenna. The operations of 908 may be performed in accordance with examples as disclosed herein. In some examples, aspects of the operations of 908 may involve power source 310 as described with reference to FIG. 3.

At 910, the method 900 may include configuring the mounting mechanism for one or both of manual deployment or automated deployment by a robotic vehicle. The operations of 910 may be performed in accordance with examples as disclosed herein. In some examples, aspects of the operations of 910 may involve mounting mechanism 308, UAV 406, and UGV 408 as described with reference to FIGS. 3 and 4.

It should be noted that the methods described herein describe possible implementations, and that the operations and the steps may be rearranged or otherwise modified and that other implementations are possible. Furthermore, aspects from two or more of the methods may be combined.

Aspect 1: A communication device, comprising: a protective housing integrating a plasmonic antenna, a conventional antenna, a power source, and a mounting mechanism; the plasmonic antenna configured to couple electromagnetic signals to surface electromagnetic waves; the conventional antenna configured to enable compatibility with standard communication systems, wherein the plasmonic antenna and the conventional antenna operate in conjunction to support a mesh network; the power source integrated with the communication device to support operation of the plasmonic antenna and the conventional antenna; and the mounting mechanism configured for one or both of manual deployment or automated deployment by a robotic vehicle.

Aspect 2: The communication device of aspect 1, further comprising a user interface integrated into the protective housing, the user interface configured to enable local configuration and monitoring of the communication device.

Aspect 3: The communication device of any of aspects 1 through 2, wherein the mounting mechanism includes a spike, auger, bolt, or adhesive, the mounting mechanism configured to secure the communication device to a surface in a dense forest or remote terrain.

Aspect 4: The communication device of any of aspects 1 through 3, further comprising a cybersecurity module integrated into the protective housing, the cybersecurity module configured to implement encryption and authentication protocols for secure communication within the mesh network.

Aspect 5: The communication device of any of aspects 1 through 4, wherein the power source includes a solar panel, a battery, or an external power connector, the power source configured to support operation of the communication device in remote terrain.

Aspect 6: The communication device of any of aspects 1 through 5, wherein the mounting mechanism is configured for UAV deployment or UGV deployment, the mounting mechanism further configured to enable installation of the communication device on varied surfaces.

Aspect 7: The communication device of any of aspects 1 through 6, wherein the protective housing is stackable, the protective housing configured to facilitate efficient transport and deployment of multiple communication devices and equipment.

Aspect 8: The communication device of any of aspects 1 through 7, wherein the plasmonic antenna is positioned within the protective housing to maximize coupling efficiency with electromagnetic signals propagating along a surface in remote terrain.

Aspect 9: The communication device of any of aspects 1 through 8, wherein the mounting mechanism is configured to enable attachment of the communication device to surfaces using manual tools or automated systems.

Aspect 10: The communication device of any of aspects 1 through 9, wherein the cybersecurity module is configured to prevent unauthorized access to communication devices and equipment by implementing multi-factor authentication protocols.

Aspect 11: The communication device of any of aspects 1 through 10, wherein the user interface is configured to provide remote access to operational settings of the communication device through a mesh network.

Aspect 12: The communication device of any of aspects 1 through 11, wherein the power source is configured to operate in low-power mode in response to periods of inactivity to extend the operational life of the communication device.

Aspect 13: A method of forming a communication device, comprising: integrating a protective housing with a plasmonic antenna, a conventional antenna, a power source, and a mounting mechanism; configuring the plasmonic antenna to couple electromagnetic signals to surface electromagnetic waves; configuring the conventional antenna to enable compatibility with standard communication systems, wherein the plasmonic antenna and the conventional antenna are operatively arranged to support a mesh network; integrating the power source to support operation of the plasmonic antenna and the conventional antenna; and configuring the mounting mechanism for one or both of manual deployment or automated deployment by a robotic vehicle.

Aspect 14: A method for using devices with plasmonic and conventional antennas for adaptable mesh network communication, comprising: receiving data signals from a device including a plasmonic antenna configured to couple electromagnetic signals to surface electromagnetic waves and a conventional antenna configured for compatibility with standard communication systems; processing the received data signals to determine network routing parameters; transmitting instructions to the device for establishing mesh network communication in response to the determined network routing parameters; and managing secure data transmission within the mesh network by applying encryption and authentication protocols to the transmitted instructions.

Aspect 15: The method of aspect 14, further comprising transmitting configuration instructions to the device for activating a modular power source selected from solar panels, batteries, or external power connectors in response to detected environmental conditions.

Aspect 16: The method of any of aspects 14 through 15, further comprising receiving deployment data from the device indicating attachment to a surface via a mounting mechanism selected from spikes, augers, bolts, adhesives, or other attachment methods.

Aspect 17: The method of any of aspects 14 through 16, further comprising transmitting control signals to the device for initiating low-power mode circuitry in response to periods of inactivity to extend operational life.

Aspect 18: The method of any of aspects 14 through 17, further comprising receiving cybersecurity status updates from the device indicating encryption and authentication protocol activity for secure communication within the mesh network.

Aspect 19: The method of any of aspects 14 through 18, further comprising transmitting deployment instructions to the device for automated installation by an unmanned system selected from UAVs, robots, or other automated systems.

Aspect 20: The method of any of aspects 14 through 19, wherein the transmitted instructions include parameters for configuring the device to operate as a repeater node within the mesh network to enhance signal propagation.

Aspect 21: The method of any of aspects 14 through 20, wherein the transmitted instructions specify activation of a user interface integrated into the device for local configuration and monitoring by an operator.

Aspect 22: The method of any of aspects 14 through 21, wherein the transmitted instructions include parameters for enabling the device to establish communication via protocols selected from Bluetooth, Wi-Fi, Ethernet, or other wired or wireless methods.

Aspect 23: The method of any of aspects 14 through 22, wherein the transmitted instructions include parameters for activating a deployment mechanism integrated into the device, selected from racks, harnesses, backpacks, or parachute attachments, in response to detected deployment scenarios.

Aspect 24: A system for using devices with plasmonic and conventional antennas for adaptable mesh network communication, comprising a processor; memory coupled with the processor; and instructions stored in the memory and executable by the processor to cause the system to perform a method of any of aspects 14 through 23.

Aspect 25: A system for using devices with plasmonic and conventional antennas for adaptable mesh network communication, comprising at least one means for performing a method of any of aspects 14 through 23.

Aspect 26: A non-transitory computer-readable medium storing code for using devices with plasmonic and conventional antennas for adaptable mesh network communication, the code comprising instructions executable by a processor to perform a method of any of aspects 14 through 23.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A communication device, comprising:
a protective housing integrating a plasmonic antenna, a conventional antenna, a power source, and a mounting mechanism;
the plasmonic antenna configured to couple electromagnetic signals to surface electromagnetic waves;
the conventional antenna configured to enable compatibility with standard communication systems, wherein the plasmonic antenna and the conventional antenna operation in conjunction to support a mesh network;
the power source integrated with the communication device to support operation of the plasmonic antenna and the conventional antenna; and
the mounting mechanism configured for one or both of manual deployment or automated deployment by a robotic vehicle.

2. The communication device of claim 1, further comprising a user interface integrated into the protective housing, the user interface configured to enable local configuration and monitoring of the communication device.

3. The communication device of claim 2, wherein the user interface is configured to provide remote access to operational settings of the communication device through a mesh network.

4. The communication device of claim 1, wherein the mounting mechanism includes a spike, auger, bolt, or adhesive, the mounting mechanism configured to secure the communication device to a surface in a dense forest or remote terrain.

5. The communication device of claim 1, further comprising a cybersecurity module integrated into the protective housing, the cybersecurity module configured to implement encryption and authentication protocols for secure communication within the mesh network.

6. The communication device of claim 5, wherein the cybersecurity module is configured to prevent unauthorized access to communication devices and equipment by implementing multi-factor authentication protocols.

7. The communication device of claim 1, wherein the power source includes a solar panel, a battery, or an external power connector, the power source configured to support operation of the communication device in remote terrain.

8. The communication device of claim 1, wherein the mounting mechanism is configured for UAV deployment or UGV deployment, the mounting mechanism further configured to enable installation of the communication device on varied surfaces.

9. The communication device of claim 1, wherein the protective housing is stackable, the protective housing configured to facilitate efficient transport and deployment of multiple communication devices and equipment.

10. The communication device of claim 1, wherein the plasmonic antenna is positioned within the protective housing to maximize coupling efficiency with electromagnetic signals propagating along a surface in remote terrain.

11. The communication device of claim 1, wherein the mounting mechanism is configured to enable attachment of the communication device to surfaces using manual tools or automated systems.

12. The communication device of claim 1, wherein the power source is configured to operate in low-power mode in response to periods of inactivity to extend the operational life of the communication device.

13. A method for using devices with plasmonic and conventional antennas for adaptable mesh network communication, comprising:
receiving data signals from a device including a plasmonic antenna configured to couple electromagnetic signals to surface electromagnetic waves and a conventional antenna configured for compatibility with standard communication systems;
processing the received data signals to determine network routing parameters;
transmitting instructions to the device for establishing mesh network communication in response to the determined network routing parameters; and
managing secure data transmission within the mesh network by applying encryption and authentication protocols to the transmitted instructions.

14. The method of claim 13, further comprising transmitting configuration instructions to the device for activating a modular power source selected from solar panels, batteries, or external power connectors in response to detected environmental conditions.

15. The method of claim 13, further comprising receiving deployment data from the device indicating attachment to a surface via a mounting mechanism selected from spikes, augers, bolts, adhesives, or other attachment methods.

16. The method of claim 13, further comprising transmitting control signals to the device for initiating low-power mode circuitry in response to periods of inactivity to extend operational life.

17. The method of claim 13, further comprising receiving cybersecurity status updates from the device indicating encryption and authentication protocol activity for secure communication within the mesh network.

18. The method of claim 13, further comprising transmitting deployment instructions to the device for automated installation by an unmanned system selected from UAVs, robots, or other automated systems.

19. The method of claim 13, wherein the transmitted instructions include parameters for configuring the device to operate as a repeater node within the mesh network to enhance signal propagation.

20. A system configured for using devices with plasmonic and conventional antennas for adaptable mesh network communication, comprising:
a processor;
memory coupled with the processor; and
instructions stored in the memory and executable by the processor to cause the system to:
receive data signals from a device including a plasmonic antenna configured to couple electromagnetic signals to surface electromagnetic waves and a conventional antenna configured for compatibility with standard communication systems;
process the received data signals to determine network routing parameters;
transmit instructions to the device for establishing mesh network communication in response to the determined network routing parameters; and
manage secure data transmission within the mesh network by applying encryption and authentication protocols to the transmitted instructions.
